(19) United States
(12) Patent Application Publication
(10) Pub. No.: US 2008/0271490 A1
(43) Pub. Date: Nov. 6, 2008

(54) CHANNEL STRUCTURE AND PROCESS FOR PRODUCTION THEREOF

(75) Inventors: Hiroyuki GOTO, Hadano-shi (JP); Hajime Sudo, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Covalent Materials Corporation, Shinagawa-ku (JP); KABUSHIKI KAISHA TOSHIBA, Minato-ku (JP)

(21) Appl. No.: 12/167,629

(22) Filed: Jul. 3, 2008

Related U.S. Application Data
(62) Division of application No. 10/846,549, filed on May 17, 2004.

(30) Foreign Application Priority Data
May 15, 2003 (JP) 2003-137452
Dec. 10, 2003 (JP) 2003-412102

(51) Int. Cl. C03B 23/00

(52) U.S. Cl. 65/102

(57) ABSTRACT

A three-dimensional (micro-) channel structure with an increased length of internal channel is provided, which can be formed without requiring a boring step for vertical hole formation. The channel structure is formed by providing a polyhedral substrate with a groove over at least two faces thereof, preferably through press molding, and covering the faces provided with the grooves with a covering member or another polyhedral substrate to form a continuous internal channel communicative with an ambience through an opening.

### CROSS REFERENCE TO RELATED APPLICATIONS

The present application is a Divisional Application of U.S. Ser. No. 10/846,549, filed May 17, 2004, and claims priority to Japanese patent application nos. 2003-137452 filed May 15, 2003, and 2003-412102 filed Dec. 10, 2003. The present application incorporates the entire contents of U.S. application Ser. No. 10/846,549 by reference.

### FIELD OF THE INVENTION AND RELATED ART

The present invention relates to a (micro-) channel structure having a relatively narrow channel extending generally three-dimensionally therein, and a process for producing such a channel structure. The present invention particularly relates to a channel structure having a three-dimensional channel therein formed by covering or sealing a groove formed in outer surfaces of a polyhedral substrate with a covering member so as to leave an opening communicative with an ambience, and a process for production thereof. Herein, a three-dimensional channel refers to a non-straight deflective channel which is not totally placed on a single plane in a channel structure.

A conventional three-dimensional (micro-) channel structure has been formed by forming two-dimensional (micro-) channels in plural layers and connecting the two-dimensional channels with a bore between the layers to provide a three-dimensional channel. Such an inter-layer bore has been formed by laser beam machining, high speed-machining, ultrasonic machining or blasting. For improving such a conventional process, there has been proposed a process wherein two-dimensional micro-channels are covered or sealed with a covering plate provided with a perforation formed by a combination of photolithography and etching for forming a more minute vertical hole, thereby providing a three-dimensional micro-channel (Japanese Laid-Open Patent Application (JP-A) 2002-370198; paragraphs [0021], [0027], [0029], FIGS. 2 and 5).

### SUMMARY OF THE INVENTION

In view of the above-mentioned circumstances, an object of the present invention is to provide a (three-dimensional micro-) channel structure which can be formed without a vertical hole formation by a boring step and can be provided with an increased length of (micro-) channel.

Another object of the present invention is to provide a process for producing a (three-dimensional micro-) channel structure, which process can provide such a (three-dimensional micro-) channel structure inexpensively and through a smaller number of steps.

According to a broad aspect of the present invention, there is provided: a channel structure, comprising: a polyhedral substrate provided with a continuous groove formed over at least two faces of the polyhedral substrate, and a covering member disposed over said at least two faces of the polyhedral substrate to cover the groove so as to form a channel communicative with an ambience.

The present invention generally provides an advantage of providing a (three-dimensional micro-) channel structure with an elongated length of channel through a process not requiring a boring step for vertical or via hole formation.

According to another aspect of the present invention, there is provided: a channel structure, comprising: a polyhedral substrate, and a covering member which has faces corresponding to at least two faces of the polyhedral substrate, is provided with a groove and is fitted to said at least two faces of the polyhedral substrate to cover the groove with said at least two faces of the polyhedral substrate so as to form a channel communicative with an ambience.

The present invention further provides a channel structure, comprising: a polyhedral substrate provided with a first groove formed in at least two faces thereof, and a covering member having faces corresponding to said at least two faces of the polyhedral substrate and provided with a second groove in the faces thereof, said faces of the covering member being fitted to said at least two faces of the polyhedral substrate so that the first and second grooves are connected with each other to form a channel communicative with an ambience.

The present invention further provides a channel structure, comprising: a polyhedral substrate provided with a groove over at least two successive faces thereof, and a plurality of covering members each being disposed to cover one of said at least two faces of the polyhedral substrate and cover the groove formed in the one face, so as to form a channel communicative with an ambience through at least two openings.

The present invention further provides a channel structure, comprising: a plurality of polyhedral substrates each provided with a continuous groove formed over in at least two successive faces thereof, said plurality of polyhedral substrates being fitted to each other to form a channel therebetween while leaving a face having an exposed groove therein; said channel structure further including a separate member disposed to cover the exposed groove, thereby forming an entire channel communicative with an ambience through at least two openings. This allows the provision of a further elongated channel.

The present invention further provides a channel structure, comprising: a plurality of first polyhedral substrates including at least one provided with a continuous groove formed over in at least two successive faces thereof, and a second polyhedral substrate not provided with a groove; said plurality of first polyhedral substrates being fitted to each other to form a channel therebetween while leaving an exposed groove, said second polyhedral substrate not provided with a groove being fitted to cover the exposed groove, thereby forming an entire channel communicative with an ambience through at least two openings. This allows the provision of a further elongated channel.

The present invention further provides a process for producing a channel structure, comprising, the steps of:

placing a polyhedral substrate of silica glass between an upper mold and a lower mold;

heating the upper and lower molds before and/or after the placing step to soften the silicate glass;

pressing the polyhedral substrate of softened silica glass between the upper and lower molds to form a continuous groove over at least two faces of the polyhedral substrate; and

covering said at least two faces provided with the groove of the polyhedral substrate with at least one covering member to form a channel structure provided with a channel communicative with an ambience.

The present invention further provides a process for producing a channel structure, comprising, the steps of:

placing a first polyhedral substrate of silica glass between an upper mold and a lower mold;

heating the upper and lower molds before and/or after the placing step to soften the silica glass;

pressing the first polyhedral substrate of softened silica glass between the upper and lower molds to form a continuous first groove over at least two faces of the first polyhedral substrate; and

covering said at least two faces provided with the first groove of the polyhedral substrate with a second polyhedral substrate already provided with a second groove so that the first and second grooves are communicative with each other, thereby forming a channel structure provided with a channel communicative with an ambience.

According to the above-mentioned processes of the present invention, it becomes possible to provide a (three-dimensional micro-) channel structure with a minute channel having a circle-equivalent diameter (i.e., a diameter of a circle giving an identical sectional area) of, e.g., ca. 10-1000 μm, preferably 10-600 μm and a length of, e.g., 10 mm to 10 m, preferably 50 mm-500 mm, inexpensively through a process including fewer steps.

In a preferred embodiment, the polyhedral substrate is provided with a groove over two or more faces thereof simultaneously in a single pressing step.

In another embodiment of the process, the lower mold is made up of plural separable parts capable of applying a pressure to side faces of the polyhedral substrate to be molded thereby. This allows a higher shape-transfer accuracy in the pressing and provides a high-definition three-dimensional micro-channel. More specifically, it becomes possible to form a minute vertical hole through a small number of step by forming a channel forming the vertical hole simultaneously in the channel-forming step. Accordingly, the vertical hole can be formed in an accuracy and a width equal to those of the channel, thereby providing a minute three-dimensional micro-channel at a low production cost.

These and other objects, features and advantages of the present invention will become more apparent upon a consideration of the following description of the present invention taken in conjunction with the accompanying drawings, wherein like parts are denoted by like reference numerals.

### BRIEF DESCRIPTION OF THE DRAWINGS

FIG. 1 is a schematic sectional view of a first embodiment of the channel structure according to the invention.

FIG. 2 is a sectional illustration of a molding apparatus used in an embodiment of the process for producing a channel structure according to the invention.

FIG. 3 illustrates a sectional side view of an upper mold and a lower mold used in the molding apparatus of FIG. 2.

FIGS. 4(a) and 4(b) show a bottom plan view of the upper mold and a top plan view of the lower mold, respectively, in the molding apparatus.

FIG. 5 is a schematic enlarged sectional view of a projection provided to an example of the lower mold.

FIG. 6 is a sectional illustration for illustrating a distribution of forces acting in the mold during compression molding.

FIG. 7 is a schematic sectional view for illustrating a second embodiment of the channel structure according to the invention.

FIG. 8 is a schematic perspective view for illustrating a third embodiment of the channel structure according to the invention.

FIGS. 9 to 11 are groups of perspective views for illustrating fourth to sixth embodiments, respectively, of the channel structure according to the invention.

FIG. 12 is a graph illustrating a relationship between the molding temperature and Gibbs energy AG (at a pressure of 1 bar) and a relationship between the molding temperature and the molding environmental pressure (at ΔG=0) for three major reactions between SiO₂ (forming a polyhedral substrate) and C (as glassy carbon forming the mold).

### DESCRIPTION OF PREFERRED EMBODIMENTS

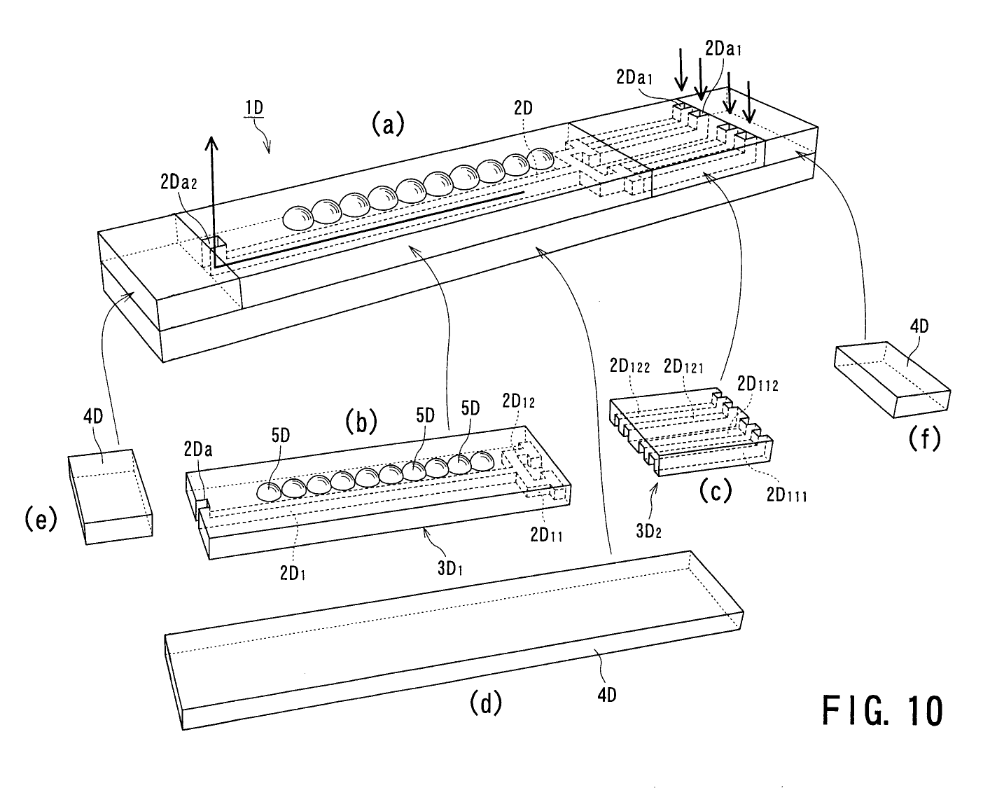

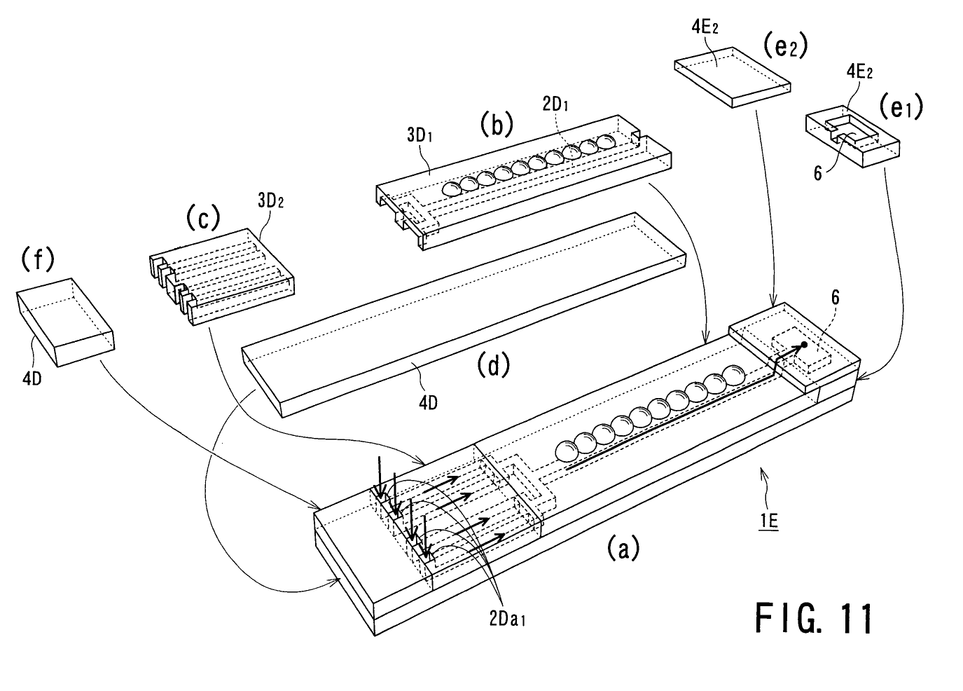

The channel structure of the present invention includes a polyhedral substrate as a first component. The term “polyhedral” generally refers to a shape formed by plane faces, e.g., as in a hexahedron (e.g., a parallelepiped), an octahedron, or an icosahedron. Although the polyhedral substrate used in the present invention is generally composed of plane faces, it can include a curved face, especially as for a face free from a groove or coverage with another member, such as a covering member or another polyhedral substrate (as in embodiments of FIGS. 10 and 11). The polyhedral substrate is generally provided with a groove formed in at least one face thereof or more typically a continuous groove formed over at least two successive faces thereof. Herein, a groove means an elongated recess. The degree of elongation of the groove is not so critical as far as it provides a channel, i.e., a relatively long fluid path, by connection with another groove. The recess can include a relatively depressed part formed between projections on a face. The channel formed in the channel structure of the present invention can be formed of (1) a continuous groove formed over a succession of faces of a single polyhedral substrate covered with (an)other covering member(s) or polyhedral substrate(s), or (2) a combination of at least one groove formed in at least one face of a polyhedral substrate and at least one groove formed in at least one face of another covering member or polyhedral substrate. The channel is communicative with an ambience generally through at least two openings but can be communicated through only one opening and the other end(s) can be connected to an inner point or space, such as an inner fluid reservoir.

Hereinbelow, the present invention will be described more specifically with reference to some preferred embodiments.

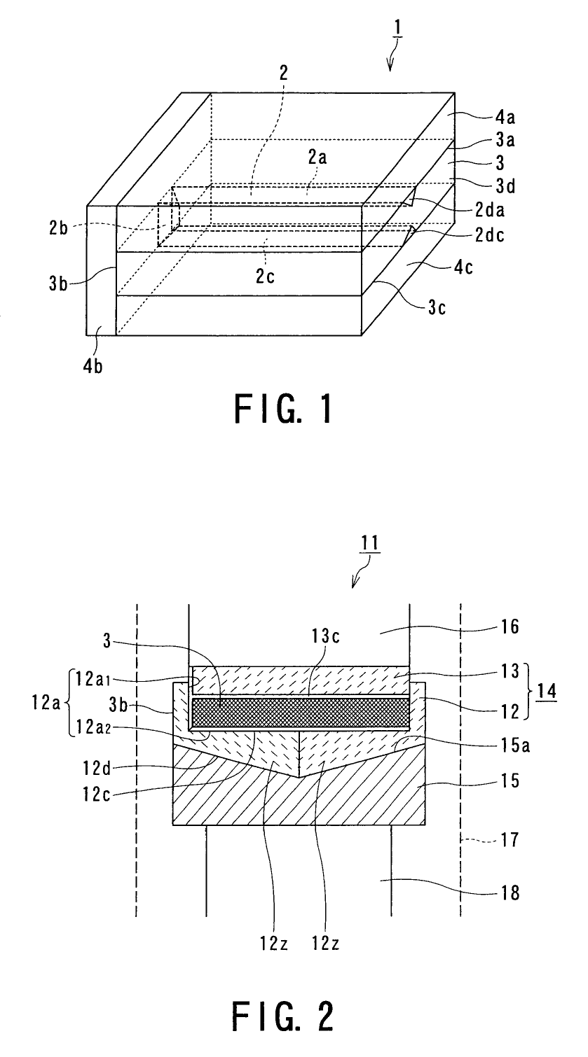

FIG. 1 is a schematic sectional view of a first embodiment of the three-dimensional micro-channel structure according to the present invention.

Referring to FIG. 1, a channel structure 1 is formed of, e.g., high-purity silica glass having a heat resistance and has an entire shape of a polyhedron, e.g., a rather flat parallel piped, as shown. The channel structure 1 is provided with a three-dimensional micro-channel 2. The channel 2 has a sectional shape of, generally, character “V” and is divided into three sections 2a, 2b, and 2c formed along or in three successive outer faces 3a, 3b, and 3c, respectively, of a polyhedral substrate 3, which are connected into an entire shape of generally tumbled character “U”. The channel 2 (or grooves forming the channel 2) is covered and sealed with separate covering members 4a, 4b, and 4c hermetically fitted to the faces of the polyhedral substrate 3 and communicated with an ambience through openings 2da and 2dc formed in an outer face 3d (a right-side face in the figure) opposite to the covering member 4b.

In this embodiment, the polyhedral substrate 3 of a parallelepiped shape is provided with an elongated channel because of the formation of a three-dimensional channel 2 of generally tumbled character U-shape therein.

Next, an embodiment of the process for providing a channel structure according to the present invention will be described.

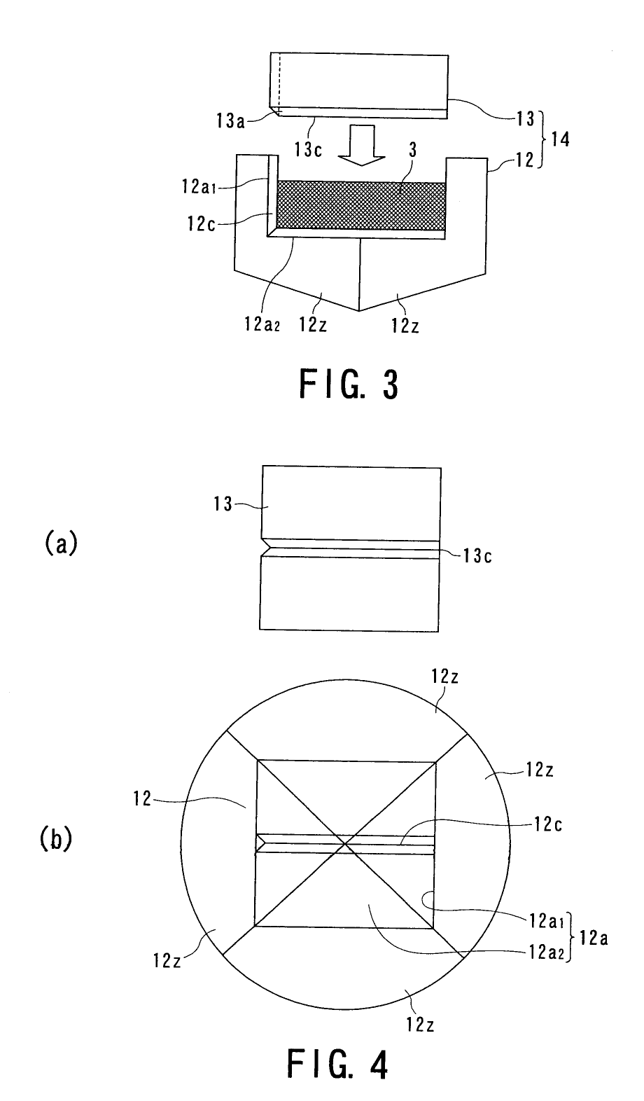

FIG. 2 is a sectional illustration of a molding apparatus used in an embodiment of the process, and FIG. 3 illustrates an upper mold and a lower mold used therein.

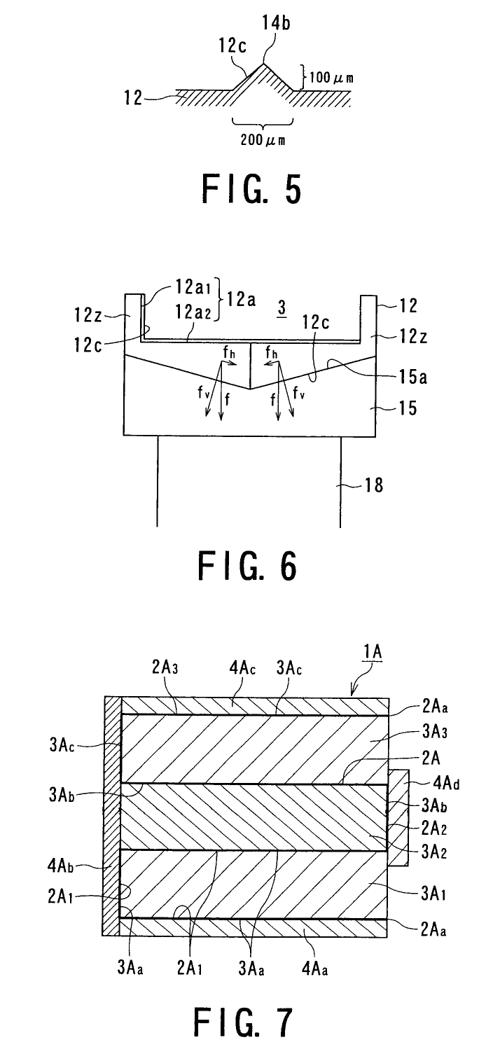

Referring to FIGS. 2 and 3, a molding apparatus 11 includes a pressing mold 14 composed of a lower mold 12 and an upper mold 13 respectively formed of glassy carbon. The lower mold 12 is provided with a square recessed molding surface 12a including a side face 12a₁ (one of four side faces) and a bottom face 12a₂ which are provided with projections 12c having a ridge 14b (as shown in FIGS. 3 to 5) and giving an overall shape of generally character “L”.

Further, the lower mold 12 is divided into 4 mold parts 12z each having a planar shape of fan, which are integrally held with their downward projections 12d fitted against a conically recessed surface 15a of a base 15. As a result, a polyhedral substrate 3 of silica glass as an objective body to be molded is held and pressed equally from four side directions, and a pressure from the pressing mold is uniformly distributed to the polyhedral substrate 3 of a flat plate shape.

The upper mold 13 has a lower molding face 13a provided with a linear molding projection 13c similarly as the lower mold 12 and is affixed to a drive shaft 16 moved up and down by oil pressure means.

In operation of the molding apparatus for molding the silica glass-made polyhedral substrate 3, the polyhedral substrate 3 is placed between the lower mold 12 and the upper mold 13, and the molds 12 and 13 are preheated prior to and/or heated after the placement of the polyhedral substrate 3, thereby softening the silica glass and pressing the polyhedral substrate 3 between the lower mold 12 and the upper mold 13.

In this instance, as shown in FIGS. 2 and 6, as the drive shaft 16 descends, a force F is applied to the substrate 3 between the drive shaft 16 and a fixed shaft 18 is divided at a contact face between the downward fit projection 12C of the lower mold 12 and the recessed fit surface 15a of the base 15 into a partial force fᵥ vertical to the contact face and a partial force fₕ parallel to the contact face. Due to the partial force fₕ, a force is exerted in a direction of moving the molding side faces 12a, of the lower mold parts 12z to each other, whereby consequently the molding side faces of the lower mold parts 12z are positively pressed against the side faces of the polyhedral substrate 3. Simultaneously, the division faces of the lower mold parts are intimately contacted to each other, whereby an adverse effect leading to a shape change of the silica glass polyhedral substrate 3 can be alleviated. Thus, the silica glass polyhedral substrate is molded so as to follow the molding face shape of the lower mold 12 and the upper mold 13.

Further, as the lower mold is equally divided into four parts in vertical planes identical in direction to the molding side faces 12a thereof, irregular pinching of the polyhedral substrate 3 due to shrinkage of the lower mold 12 is prevented, and the force f exerted to the lower mold 12 is readily converted into a partial force fₕ for pulling the molding side faces 12a to each other. Further, as the downward fit projection 12d of the lower mold 12 and the recessed fit surface 15a of the base 15 are shaped in cones or pyramids, the force f exerted to the lower mold 12 is surely converted to generate the partial force fₕ functioning to pull the molding side faces 12aᵢ to each other.

Further, even if the thermal expansion coefficient of the mold cannot be made equal to or smaller than that of the polyhedral substrate 3 to be molded, the partial force fₕ also functions to resist and overcome a force functioning to enlarging the lower mold 12 in horizontal directions caused by horizontal expansion of the polyhedral substrate 3 due to the thermal expansion and owing to the actions of the force f, thereby pulling the molding faces 3a₁ to each other. As a result, side walls of the polyhedral substrate 3 can be accurately molded by press-molding without irregular deformations at peripheral portions of the polyhedral substrate 3. Further, as a molding pressure can be applied securely from all the molding faces of the mold, if a transfer pattern is provided to the press-mold, the transfer pattern, inclusive of inscriptions or special pattern, can be accurately transferred to every corner of the polyhedral substrate 3 of silica glass at an improved transfer accuracy. Further, even in case where irregular pinching of the silica glass polyhedral substrate 3 is liable to occur due to a difference in thermal expansion coefficient between the mold material and the polyhedral substrate 3, accurate press-molding can be achieved with accurately controlled side-face molding. Thus, due to the press-forming steps as described above, a groove formation providing a minute three-dimensional micro-channel can be achieved at a high transfer accuracy.

After the formation of grooves in the three outer faces 3a, 3b, and 3c of the polyhedral substrate 3, separate covering members 4a, 4b, and 4c are respectively fitted and applied hermetically to the faces 3a, 3b, and 3c, respectively to form a channel structure having a channel 2 including channel sections 2a, 2b, and 2c and communicating with an ambience through openings 2da and 2dc as shown in FIG. 1.

According to the above-described process, the groove formation is applied to every directional face (totally three faces in the above-described embodiment) of a polyhedral substrate to allow the formation of a minute vertical hole through a small number of steps by forming a vertical hole simultaneously in a channel forming step, whereby it becomes possible to produce a three-dimensional micro-channel structure including a vertical hole having an identical width as horizontal channels (or paths) at equal accuracy in an inexpensive manner.

In the above-described process for producing a three-dimensional (micro-) channel structure according to the invention, the polyhedral substrate 3 may be composed of any material adapted for press-molding. The process is especially adapted to a material not suitably applied to a vertical hole formation as by machining or laser beam processing, unlike metals. For providing a transparent channel structure, the polyhedral substrate may preferably be formed of a transparent material. More specifically, examples of preferred materials for the polyhedral substrate may include: glass and resins, of which silica glass is particularly preferred because it has a relatively low softening temperature and adapted to high-definition formation by high-temperature press-molding. More specifically, it is preferred to use synthetic silica glass, such as oxyhydrogen flame fusion process silica glass or VAD (vapor-phase axial deposition) synthetic silica glass, having an OH group content of 400-1200 ppm.

As the material for the lower mold 12 and the upper mold 13 of the pressing mold 14 for press molding into a polyhedral substrate 3 of silica glass requiring a molding temperature of at least 1360° C., it is particularly preferred to use glassy carbon which has an excellent high-temperature strength and provides a smooth molding face.

In this instance, as a result of intense study, we have clarified relationships of temperature and pressure regarding reaction between silicon dioxide (SiO₂) forming the silica glass and carbon (C) forming the glassy carbon, and have found it critical to effect the press molding in specific ranges of temperature and pressure for effectively suppressing the difficulties in the press molding, inclusive of the conversion of the glassy carbon into SiC caused by an excessively high temperature, the conversion into SiC caused at a low environmental pressure in a certain high-temperature range, and the occurrence of air stagnation caused by an insufficiently reduced pressure.

More specifically, in view of the shortening of the press molding time and the prevention of the reaction between the glassy carbon (forming the mold) and the silica glass to be molded, it is particularly preferred that the pressing temperature is set within a range of 1430 to 1460° C., more preferably 1430 to 1450° C. The heating of the mold may preferably be effected by means of an infrared lamp, an Mo or W metal heater, a high-frequency induction heater, etc.

The press molding environment (within the mold) may preferably be an inert gas atmosphere at a (somewhat) reduced pressure, i.e., a pressure below an atmospheric pressure (of normally, ca. 1 bar=100,000 Pa). In order to prevent the occurrence of air stagnation in the mold, the environmental pressure may preferably be at most 50000 Pa, particularly at most 40000 Pa. According to our study, it has been discovered that a certain low pressure is liable to promote the SiC-forming reaction between silica glass and glassy carbon even in the above-described temperature range, and a pressure of at least 3600 Pa is preferred to prevent the reaction.

More specifically, in order to more reliably control and suppress the SiC-forming reaction in the molding temperature range of 1430-1460° C., it has been also found more preferable to set the molding environment pressure to a pressure P which is at most 46000 Pa and equal to or above a pressure P determined according to the following formula (I):

P=(4×10⁵¹×T^{17.425}−0.4445×T²+1228.7×T−851921)Pa (I),

wherein T denotes the above-mentioned molding temperature (° C.). The significance of the formula (I) is explained below.

Several reaction schemes have been known between SiO₂ and C, inclusive of major reaction schemes represented by the following formulae (1) to (3):

SiO₂+C=SiO(g)+CO(g) (1)

SiO₂+2C=Si+2CO(g) (2)

SiO₂+3C=SiC+2CO(g) (3)

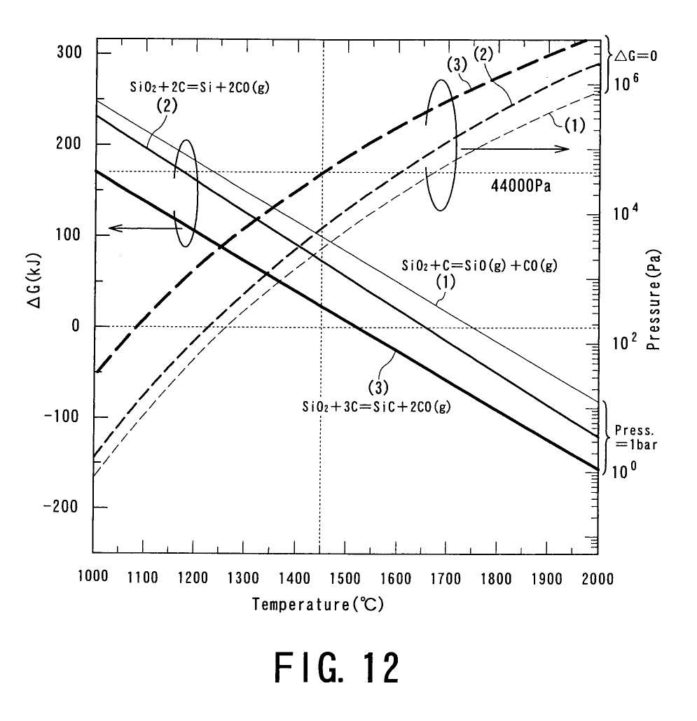

Three linear lines (solid lines) (1)-(3) in FIG. 12 represent relationships between temperatures (° C.) and Gibbs energy ΔG(kJ) under a pressure of 1 bar for the reactions (1)-(3), respectively. The respective reactions are allowed to proceed in temperature ranges where the corresponding linear lines (1)-(3) are below a horizontal line representing ΔG=0 (left ordinate). From FIG. 12, it is understood that the reaction (3) of SiO₂+3C=SiC+2CO(g) occurs at lowermost temperatures.

FIG. 12 also shows three curves (dashed lines) (1)-(3) which represent pressures (right ordinate) giving a Gibbs energy ΔG=0 at varying temperatures for the respective reactions (1) to (3). FIG. 12 shows that the reactions (1)-(3) do not substantially occur in the pressure regions above the curves (1)-(3), respectively.

The above equation (1) gives a good approximation of the curve (3) at arbitrary temperatures in the range of T=1430 to 1460° C., while a complex calculation is required to derive pressures giving ΔG=0 at various temperatures represented by the curve (3) in FIG. 12.

For example, it is shown from the curve (3) in FIG. 12 (and the approximation formula (I)), any reactions between SiO₂ and C is effectively prevented in a pressure range of 44000 Pa or above at a temperature of 1450° C. The approximate formula (I) gives such a lowermost pressure for securely avoiding the undesirable SiC forming reaction easily at arbitrary molding temperatures in the range of 1430 to 1460° C.

The press molding environment may preferably be an atmosphere of an inert gas, which is particularly preferably at least one of N₂, Ar, and He.

FIG. 7 is a schematic sectional view of a second embodiment of the channel structure according to the present invention wherein a plurality of polyhedral substrates each provided with a three-dimensional channel (or groove giving the channel) are laminated to provide a channel structure, in contrast with the first embodiment wherein one polyhedral substrate provided with a three-dimensional channel is used.

Referring to FIG. 7, a three-dimensional channel structure 1A includes a first polyhedral substrate 3A1 provided with 2A1 in an overall shape of generally tumbled “U” over three successive outer faces 3Aa thereof, a second polyhedral substrate 3A2 provided with a groove 2A2 in an overall shape of generally “L” over two successive outer faces 3Ab, and a third polyhedral substrate 3A3 (similarly as the second substrate 3A2) provided with a groove 2A3 in a shape of generally “L”. The first, second and third polyhedral substrates (3A1, 3A2 and 3A3) are stacked so that the grooves 2A1, 2A2 and 2A3 are communicated with each other to form an entire channel 2A. Further, the exposed faces 3Aa, 3Ab and 3Ac provided with yet uncovered grooves (or channels) are covered with separate covering members 4Aa, 4Ab, 4Ac and 4Ad hermetically fitted thereto to provide an entire channel structure 1A with an entire internal channel 2A (having sections 2A1, 2A2, and 2A3) which is communicated with an ambience through two openings 2Aa.

The channel structure according to this embodiment is provided with an increased length of channel owing to the use of plural polyhedral substrates each provided with a three-dimensional channel.

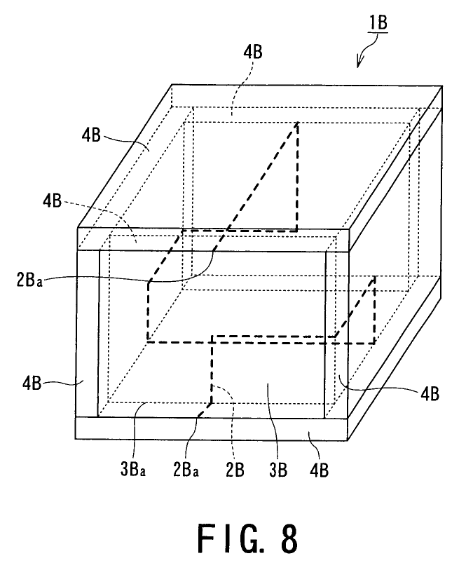

FIG. 8 is a schematic perspective view of a third embodiment of the channel structure according to the present invention, including a polyhedral substrate of which all the faces are provided with a channel (or grooves giving the channel).

Referring to FIG. 8, a channel structure 1B includes a parallel piped polyhedral substrate 3B, of which all the faces 3Ba are provided with grooves 2B. The faces 3Ba provided with the grooves 2B of the polyhedral substrate 3B are covered with separate covering members 4B hermetically fitted thereto to form a continuous internal channel 2B which is communicated with an ambience through two openings 2Ba.

In this embodiment, all the faces of a polyhedral substrate are provided with grooves, so that a further increased length of channel is formed over a single polyhedral substrate. All the grooves on all the faces of the polyhedral substrate 3B can be formed by a single molding step, thus at an improved productivity.

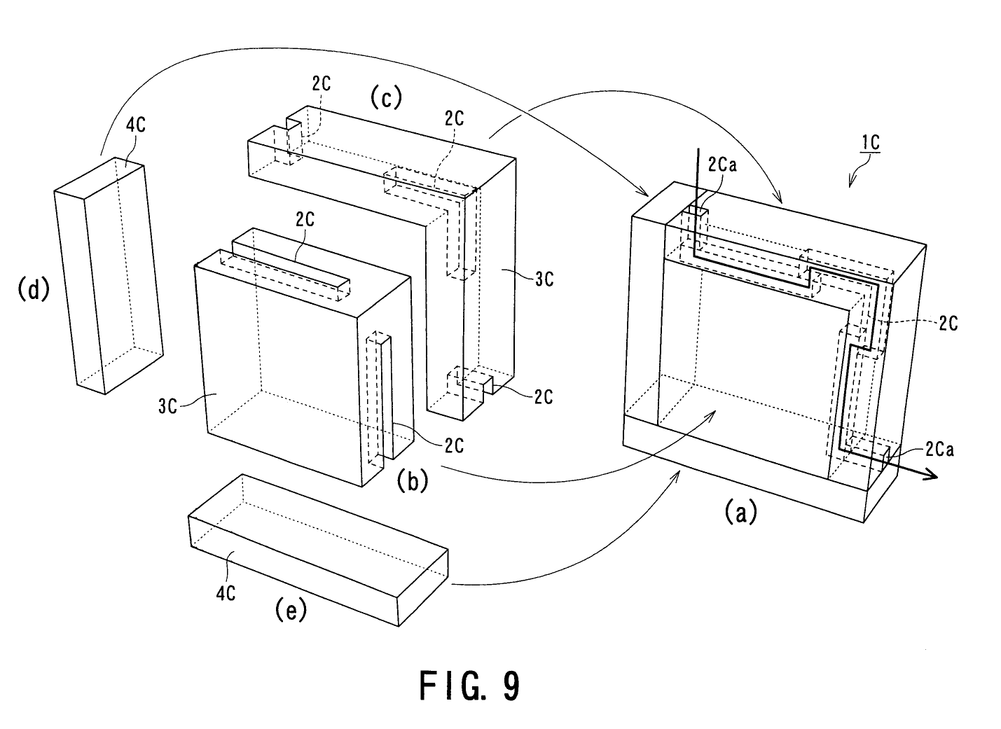

FIG. 9 is a group of schematic perspective views for illustrating a fourth embodiment of the channel structure according to the present invention.

More specifically, referring to FIG. 9, at (a) is shown an entire structure of a channel structure 1C in an assembled state, and at (b) to (e) are shown parts thereof giving the channel structure. More specifically, at (b) is shown a polyhedral substrate 3C provided with discrete grooves 2C on separate faces thereof. At (c) is shown an elbow-shaped second polyhedral substrate 3C (which may also be regarded as a covering member 4C) provided with three discrete grooves 2C, including two at two ends thereof and one at its inner elbow face. The inner faces provided with the grooves 2C of the second polyhedral substrate 3C (FIG. 9(c)) are fitted to the two faces provided with the grooves 2C of the first polyhedral substrate 3C (FIG. 9(b)), so that their grooves are communicated to provide a continuous channel 2C. FIGS. 9(d) and 9(e) shows two covering members which are fitted to the left face and the bottom face, respectively, of the first polyhedral substrate 3C (FIG. 9(b)) to provide an entire channel structure shown in FIG. 9(a) wherein a continuous internal channel 2C is provided so as to be communicative with an ambience through two openings 2Ca as represented by a thick line headed with an arrow in FIG. 9(a).

FIG. 10 is a group of schematic perspective views for illustrating a fifth embodiment of the channel structure according to the present invention, which has been devised as a flow analyzer for analyzing a state of mixing of two fluids (which are two mixtures of originally four fluids) introduced in mixture to a channel.

More specifically, referring to FIG. 10, at (a) is shown an entire structure of a channel structure in an assembled state, and at (b) to (f) are shown parts thereof giving the channel structure. More specifically, at (b) is shown a first polyhedral substrate 3D1 provided with a linear array of projecting microlenses 5D on its upper face and a main groove 2D1 on its lower face. The main groove 2D1 is bent and extended upward on a left face of the polyhedral substrate 3C1 to reach the upper face of the substrate 3D1. The groove 2D1 is extended rightwards and divided into two grooves which are enlarged at the right face of the polyhedral substrate 3D1 to provide two openings. The microlenses 5D are arranged in line with the groove 2D1 so as to see the groove 2D1 through the substrate 3D1. At (c) is shown a second polyhedral substrate 3D2 which is provided with four grooves, i.e., two grooves 2D111 and 2D112 (designed to be communicative with the groove 2D12) and two grooves 2D121 and 2D122 (designed to be communicative with the grooves 2D11), on its lower face. The grooves 2D111, 2D112, 2D121, and 2D122 are bent and extended on a right face of the substrate 3D2 to reach the upper face of the substrate 3D2. The left face of the substrate 3D2 is fitted to the right face of the substrate 3D1 so that their four grooves (of 3D2) and two grooves (of 3D1) are communicated with each other. Further a covering member 4D shown at FIG. 10(e) is fitted to the left face of the polyhedral substrate 3D1, and a covering member 4D shown at FIG. 10(f) is fitted to the right face of the polyhedral substrate 3D2. Finally, a bottom covering member (plate) 4D shown at FIG. 10(d) is fitted to the lower faces of the substrates 3D1 and 3D2, and the covering members 4D, to cover the grooves 2D1, 2D11, 2D12, 2D111, 2D112, 2D121, and 2D122, thereby providing a continuous channel 2D1 branched rightwards into two channels 2D11 and 2D112 which are further branched into four channels 2D111, 2D112, 2D121, and 2D122. As a result, an entire channel structure as shown at FIG. 10(a) is provided with a continuous internal channel 2D communicated with an ambience through 4 openings 2Da1 on a right side and one opening 2Da2 on a left side.

In operation of the channel structure 1D shown at FIG. 10(b), at most four fluids are introduced through the openings 2Da1 into the channels 2D111, 2D112, 2D121, and 2D122 and mixed at the connection of the substrates 3D2 and 3D1 to provide two mixture fluids flowing through channels 2D11 and 2D12, which are further combined into a single stream flowing through the channel 2D1 in the substrate 3D1. The mixed fluid flowing through the channel 2D1 is optically analyzed through the array of microlenses 5D provided on the upper face of the substrate 3D1 and through a main body of the substrate 3D1. For example, the mixed fluid is optically analyzed by illuminating the fluid with a specific wavelength of light to capture a transmission picture thereof, or measure a wavelength, spectrum or intensity of light modulated with the fluid. After the examination through the microlens array, the fluid passing through the channel 2D1 is allowed to exit through the opening 2Da2 to the ambience.

FIG. 11 is a group of schematic views for illustrating a sixth embodiment of the channel structure according to the present invention.

The sixth embodiment is similar to the fifth embodiment illustrated by FIG. 10, and similarly functions as a flow analyzer, while they are illustrated in laterally opposite dispositions.

The sixth embodiment is different from the fifth embodiment only in that the second opening (i.e., fluid exit) 2Da2 is omitted and replaced with an internal reservoir 6. For this purpose, the covering member 4D shown at FIG. 10(e) is replaced by a combination of a covering member (or a third polyhedral substrate) 4E1 provided with a relatively large recess 6 and a flat covering member 4E2 covering the recess together with the right end of the channel 2D1 communicative with the recess 6 to provide the reservoir 6.

In operation of the flow analyzer shown at FIG. 11(a), the fluid after examination through the channel 2D1 is once held in the reservoir, and after the examination, the covering members 4E1 and 4E2 are removed from the flow analyzer to empty the reservoir 6 and refitted to prepare for a subsequent flow analyses.

### (Further Embodiments or Modifications)

The channel structure of the present invention has been described with reference to some preferred embodiments thereof. It is however believed apparent to one of ordinary skill in the art that the present invention is not restricted to these embodiments and can be modified in various ways in the ambit of the present invention.

For example, the sectional shape of the grooves (and thus the channels formed therefrom) can be any arbitrary shape, instead of a triangle (or V shape) as shown in FIGS. 1 to 6, though it is a preferred shape, or a rectangle as shown in FIGS. 9 to 11, as far as it does not obstruct the press molding of the polyhedral substrate or covering member. For example, an open trapezoid is another preferred example of groove sectional shape.

As is understood from the above description, the difference between the polyhedral substrate and the covering member is not so strict. The term polyhedral substrate is generally used as referring to a member provided with a groove and formed through press molding. However, the covering member can be also formed through press molding as far as it is formed of a material adapted for press molding. The covering member can also have a shape of a polyhedron, while it has a shape of simple parallelepiped, such as a rectangular plate, in most cases but can have another shape when it is formed by a method other than press molding. The covering member is preferably transparent (and therefore formed of a transparent material like that of a polyhedral substrate) if it is fitted to cover a face of the polyhedral substrate expected to be seen therethrough, but can be formed of an opaque material if seeing therethrough is not required.

As described above, the present invention provides a three-dimensional (micro-) channel structure with an increased length of internal (micro-) channel that can be produced without requiring a boring step for formation of a vertical hole.

The present invention further provides a process for producing a three-dimensional (micro-) channel structure which allows the production of a three-dimensional (micro-) channel structure with minute internal channels at a low production cost.

What is claimed is:

1. A process for producing a channel structure, comprising, the steps of:
placing a polyhedral substrate of silica glass between an upper mold and a lower mold;
heating the upper and lower molds before and/or after the placing step to soften the silica glass;
pressing the polyhedral substrate of softened silica glass between the upper and lower molds to form a continuous groove over at least two faces of the polyhedral substrate; and
covering said at least two faces provided with the groove of the polyhedral substrate with at least one covering member to form a channel structure provided with a channel communicative with an ambience.

2. A process according to claim 1, wherein the pressing of the polyhedral substrate is effected in a single step so as to simultaneously form the groove over said at least two faces.

3. A process according to claim 1, wherein the lower mold is composed of plural parts so as to apply a pressure to side faces of the polyhedral substrate during the pressing step.

4. A process according to claim 1, wherein the upper and lower molds are formed of glassy carbon, and the pressing step is operated at a temperature of 1430 to 1460° C. under a pressure of 3600 Pa to 50000 Pa.

5. A process according to claim 4, wherein the pressing step is operated at a pressure not lower than (4×10⁻⁵¹T^{17.425}−0.445×T²+1228.7×T−851921)Pa.

6. A process according to claim 5, wherein the pressing step is operated at a pressure of at most 46000 Pa.

7. A process according to claim 1, wherein the pressing step is operated in an atmosphere of an inert gas.

8. A process according to claim 7, wherein the inert gas comprises at least one of N₂, Ar, and He.

9. A process according to claim 1, wherein the upper and lower molds are heated by means of an infrared lamp, an Mo or W metal heater or a high-frequency induction heater.

10. A process according to claim 1, wherein the silica glass is synthetic silica glass formed through oxyhydrogen flame fusion process or VAD synthetic silica glass and has an OH group content of 400-1200 ppm.

11. A process for producing a channel structure, comprising, the steps of:
placing a first polyhedral substrate of silica glass between an upper mold and a lower mold;
heating the upper and lower molds before and/or after the placing step to soften the silicate glass;
pressing the first polyhedral substrate of softened silica glass between the upper and lower molds to form a continuous first groove over at least two faces of the first polyhedral substrate; and
covering said at least two faces provided with the first groove of the first polyhedral substrate with a second polyhedral substrate already provided with a second groove so that the first and second grooves are communicative with each other, thereby forming a channel structure provided with a channel communicative with an ambience.

12. A process according to claim 11, wherein the pressing of the polyhedral substrate is effected in a single step so as to simultaneously form the groove over said at least two faces.

13. A process according to claim 11, wherein the lower mold is composed of plural parts so as to apply a pressure to side faces of the polyhedral substrate during the pressing step.

14. A process according to claim 11, wherein the upper and lower molds are formed of glassy carbon, and the pressing step is operated at a temperature of 1430 to 1460° C. under a pressure of 3600 Pa to 50000 Pa.

15. A process according to claim 14, wherein the pressing step is operated at a pressure not lower than (4×10⁻⁵¹T^{17.425}−0.445×T²+1228.7×T−851921)Pa.

16. A process according to claim 15, wherein the pressing step is operated at a pressure of at most 46000 Pa.

17. A process according to claim 11, wherein the pressing step is operated in an atmosphere of an inert gas.

18. A process according to claim 17, wherein the inert gas comprises at least one of N₂, Ar, and He.

19. A process according to claim 11, wherein the upper and lower molds are heated by means of an infrared lamp, an Mo or W metal heater or a high-frequency induction heater.

20. A process according to claim 11, wherein the silica glass is synthetic silica glass formed through oxyhydrogen flame fusion process or VAD synthetic silica glass and has an OH group content of 400-1200 ppm.
